(19) United States
(12) Patent Application Publication
(10) Pub. No.: US 2025/0368176 A1
(43) Pub. Date: Dec. 4, 2025

(54) GEARING ASSEMBLY FOR A BRAKE ACTUATOR, AND BRAKE ACTUATOR

(71) Applicant: IMS GEAR SE & CO. KGAA, Donaueschingen (DE)

(72) Inventors: Fabian GRULER, Aixheim (DE); Wilfried SYNOVZIK, Hüfingen (DE)

(21) Appl. No.: 18/874,066

(22) PCT Filed: Jul. 21, 2022
(86) PCT No.: PCT/EP2022/070476

§ 371 Date: Dec. 11, 2024

(30) Foreign Application Priority Data
Jun. 13, 2022 (EP) 22178777.3

(51) Int. Cl. B60T 13/74; F16D 7/04; F16D 41/066; F16D 65/16; F16D 121/24; F16D 125/50; F16H 37/04

(52) U.S. Cl. CPC B60T 13/741; F16D 7/044; F16D 41/066; F16D 65/16; F16H 37/041; F16D 2121/24; F16D 2125/50; F16H 2200/0034; F16H 2200/2005; F16H 2200/2082

(57) ABSTRACT

A gearing assembly (12) for a brake actuator (10), comprising the following features:
a drive element (33),
a first driven element (36),
a second driven element (38), and
a gearing output element (40),
wherein, with respect to the drive element (33), the first driven element (36) has a different transmission ratio than the second driven element (38),
wherein the first driven element (36) can be coupled to the gearing output element (40) by a first clutch (42), which comprises a first drive body (50) and a first driven body (52), and
wherein the second driven element (38) can be coupled to the gearing output element (40) by a second clutch (46), which comprises a second drive body (62) and a second driven body (64) and is designed as an overrunning clutch,
   and a brake actuator (10) comprising a gearing assembly (12).

The invention relates to a gearing assembly for a brake actuator and to a brake actuator.

Brake actuators are subject to high dynamic demands, in particular in the automotive sector. In order to meet these dynamic demands, electromechanical brake actuators have hitherto been equipped with low-reduction gearings with brushless direct current motors (known as brushless DC motors or BLDC motors) as drive motors. However, these motors are very costly, which is why alternative concepts are being sought.

Costs can be reduced by using conventional, i.e., brushed, direct current motors (known as DC motors) as drive motors. Due to the relatively low motor output torques provided by a drive motor of this kind, a downstream gearing has to provide a correspondingly high reduction ratio in order to achieve the required adjustment forces. However, the high reduction ratio comes at the expense of the adjustment time. In particular, the time required to lock the brake (“time to lock”: TTL) is essential for highly dynamic braking systems.

It is therefore the object of the invention to provide a gearing assembly which allows for the required adjustment forces to be achieved, which can achieve a short time to lock, and which, moreover, can be produced easily and inexpensively. In particular, the gearing assembly should be so cost-effective to produce that the cost advantage achieved by using a DC motor compensates for the higher production costs of the gearing assembly.

It is also the object of the invention to provide a brake actuator that can be produced cost-effectively and which provides the required adjustment forces while at the same time having a short time to lock.

The object is achieved according to the invention by a gearing assembly having the features of claim 1 and by a brake actuator having the features of claim 16.

Advantageous embodiments and developments of the invention are specified in the dependent claims.

A gearing assembly according to the invention for a brake actuator comprises a drive element, a first driven element, a second driven element, and a gearing output element, wherein, with respect to the drive element, the first driven element has a different transmission ratio than the second driven element. As a result, when the gearing assembly is in operation, a rotational speed and a torque can be picked up at the first driven element which differ, respectively, from the rotational speed and the torque that can be picked up at the second driven element.

In the gearing assembly according to the invention, the first driven element can further be coupled to the gearing output element by a first clutch which comprises a first drive body and a first driven body. The second driven element can be coupled to the gearing output element by a second clutch, which comprises a second drive body and a second driven body and is designed as an overrunning clutch. The gearing output element may, for example, be in operative connection to a brake shoe. For this purpose, the gearing output element may have splines.

In a first embodiment of the invention, the first clutch is designed as a torque-limiting clutch. A torque-limiting clutch is understood here and throughout the document to mean preferably a clutch which couples or decouples two bodies to or from one another depending on the torque to be transmitted. The first clutch of the gearing assembly described here is preferably configured such that small torques up to a particular torque limit can be transmitted by the clutch. An overrunning clutch is understood here and throughout the document to mean preferably a clutch which couples or decouples two bodies to or from one another according to the principle of a freewheel depending on the rotational direction to be transmitted. In particular, such a second clutch can decouple two bodies rotating at different rotational speeds in the same direction from one another.

Preferably, the second clutch is designed as a freewheel, in particular a roller-type freewheel or sprag freewheel. A roller-type freewheel preferably has rolling elements that roll in the uncoupled state and are disengaged by clamping springs in the coupled state. This enables a delay-free switching process from the coupling of the first driven element to the gearing output element to the coupling of the second driven element to the gearing output element.

Depending on the load applied to the gearing output element and the rotational direction of the first driven element and of the second driven element, either the rotational speed and torque of the first driven element or the rotational speed and torque of the second driven element can be transmitted to the gearing output element. This allows for the transmission ratio of the gearing output element to the drive element to be changed on the basis of the load applied to the gearing output element.

The first driven element and the second driven element preferably represent two different flows and paths of force through the gearing assembly, which may include the gearing output element depending on the operating state. The first clutch and the second clutch can prevent the gearing assembly from becoming misaligned, i.e., locked. Preferably, the gearing assembly is configured such that the first driven element has a higher rotational speed and a lower torque during operation than the second driven element. The first driven element and the second driven element are preferably coupled to the drive element such that the first driven element and the second driven element have the same rotational direction.

The gearing assembly of the first embodiment can thus have the following operating states:

In a first possible operating state, the first driven element and the second driven element rotate in a first rotational direction. No load is applied to the gearing output element or a load not exceeding the torque limit of the first clutch is applied. The first clutch couples the gearing output element to the first driven element. The second clutch decouples the gearing output element from the second driven element and thus enables the slower rotating second driven element to be “overtaken” by the faster rotating gearing output element. The gearing output element has the rotational speed and torque of the first driven element. This operating state can occur, for example, if a brake shoe that is in operative connection with the gearing output element moves through the running clearance of a brake, i.e., the distance to coming into contact with the brake disk.

In a second possible operating state, the first driven element and the second driven element also rotate in the first rotational direction. A load exceeding the torque limit of the firts clutch is applied to the gearing output element that. The first clutch decouples the gearing output element from the first driven element. Once the rotational speed of the gearing output element has dropped to at least the rotational speed of the second driven element, the second clutch couples the gearing output element to the second driven element. The gearing output element therefore has the rotational speed and torque of the second driven element. This operating state can occur, for example, if the brake shoe that is in operative connection with the gearing output element is in contact with the brake disk and is pressed against the brake disk.

In a third possible operating state, the first driven element and the second driven element rotate in a second rotational direction opposite to the first rotational direction. No load is applied to the gearing output element or a load not exceeding the torque limit of the first clutch is applied. The first clutch could therefore couple the gearing output element to the first driven element. Due to the principle of the overrunning second clutch, the higher rotational speed of the first driven element in the second rotational direction compared to the rotational speed of the second driven element can lead to the gearing output element becoming coupled to the second driven element. As a result, the torque-limiting first clutch can decouple the gearing output element from the first driven element. The gearing output element has the rotational speed and torque of the second driven element. This operating state can occur, for example, if the brake shoe that is in operative connection with the gearing output element moves away from the brake disk.

Preferably, the first drive body of the first clutch is non-rotatably connected to the first driven element. The first drive body can be form-fittingly and/or integrally connected to the first driven element, in particular in the circumferential direction. In the first embodiment of the invention, the first drive body can be preloaded against the first driven body by a spring element. As a result, the first clutch can couple the gearing output element to the first driven element by means of a frictional and/or form-fitting connection. The torque limit of the first clutch can be adjusted by preload. The spring element is preferably designed as a spring washer.

In particular, in the first embodiment of the invention, the first driven body of the first clutch can be formed by the gearing output element. This allows for a compact design and a smaller number of parts in the gearing assembly to be achieved.

In particular, in the first embodiment of the invention, the first drive body can be designed as a toothed disk and the gearing output element can have a contour that can be brought into engagement with the toothed disk on an end face facing the toothed disk. A toothed disk is preferably understood to be a disk-shaped element which has a toothed profile in the axial direction. Such an arrangement makes it possible to reduce the spring force required to couple the drive part to the gearing output element while maintaining the torque limit of the first clutch.

In a second embodiment of the invention, the first clutch is designed as a rotational-angle-actuated clutch. A rotational-angle-actuated clutch is understood here and throughout the document to mean preferably a clutch which couples or decouples two bodies to or from one another depending on the rotational angle of at least one of the two bodies. In the second embodiment of the invention, the coupling or decoupling preferably depends on the rotational angle of the first driven body. Depending on the rotational angle of the first driven body, either the rotational speed and torque of the first driven element or the rotational speed and torque of the second driven element can be transmitted to the gearing output element. This allows for the transmission ratio of the gearing output element to the drive element to be changed on the basis of the rotational angle of the first driven body. Thus, the rotational speed applied to the gearing output element and the corresponding torque can be controlled as a function of the rotational angle and therefore the travel.

The second embodiment of the gearing assembly is preferably designed such that the first driven body has a toothed segment which is non-rotatably coupled to the gearing output element, and the first drive body has drive teeth which can be brought into engagement with the toothed segment. The non-rotatable coupling of the toothed segment to the gearing output element is preferably to be understood to mean that a relative movement of the toothed segment causes a relative movement of the gearing output element and vice versa. Here and throughout the document, the toothed segment is preferably understood to mean a non-continuous arrangement of a toothing geometry. Accordingly, the toothed segment can be arranged, for example, on the circumference of a toothed-segment gear over a toothed-segment angle of less than 360°. This means that the toothed segment can engage with the drive teeth only within the toothed-segment angle. Within the toothed segment, the first drive body and the first driven body may be coupled to each other. In addition, there is preferably no longer any force transmission between the drive teeth and the toothed segment. The first drive body and the first driven body may thus be decoupled from each other. The first drive body may be formed by the first driven element.

In the second embodiment of the gearing assembly, the first driven element can preferably be coupled to the drive element by means of a third clutch. As a result, the force path comprising the first driven element and the force path comprising the second driven element can be decoupled from one another on the drive element side. In the case of rotation in the first rotational direction, the decoupling function is preferably performed by the second clutch. In the case of rotation in the second rotational direction, which in the second embodiment of the gearing assembly is preferably driven from the gearing output element, the second clutch is closed due to the principle of overrunning actuation. The first clutch, designed as a rotational-angle-actuated clutch, is typically not able to open in the event of a torque increase caused by the misalignment of the gearing assembly, as can happen in the first embodiment. Misalignment of the gearing can therefore be avoided by providing the third clutch.

Particularly preferably, the third clutch is designed as an overrunning clutch. This allows for the first driven element to be driven by the drive element in the first rotational direction, whereas, in the second rotational direction, misalignment of the gearing assembly can be avoided. An overrunning clutch can be a simple and spacesaving option while simultaneously being highly efficient. The third clutch is preferably designed as a freewheel, particularly preferably a sprag freewheel.

In accordance with the first embodiment, possible operating states of the second embodiment of the gearing assembly will be explained below:

In a first possible operating state, the drive element rotates in a first rotational direction, so that the second driven element, which is preferably non-rotatably coupled to the drive element, also rotates in a first rotational direction. The third clutch is preferably configured to transmit torque from the drive element to the first driven element in the first rotational direction. The drive teeth of the first drive body engage with the toothed segment so that the first clutch couples the gearing output element to the first driven element. The second clutch decouples the gearing output element from the second driven element and thus enables the slower rotating second driven element to be “overtaken” by the faster rotating gearing output element. Rotational speed and torque are transmitted from the first driven element to the gearing output element, which also rotates in a first rotational direction. This operating state can occur, for example, if a brake shoe that is in operative connection with the gearing output element moves through the running clearance of a brake, i.e., the distance to coming into contact with the brake disk.

In a second possible operating state, the drive element also rotates in the first rotational direction. The toothed segment has moved so far that there is no longer any force transmission between the drive teeth and the toothed segment. The first clutch thus decouples the gearing output element from the first driven element. Once the rotational speed of the gearing output element has dropped to at least the rotational speed of the second driven element, the second clutch couples the gearing output element to the second driven element. Rotational speed and torque are transmitted from the second driven element to the gearing output element. The gearing output element rotates in the first rotational direction. If the toothed segment is non-rotatably coupled to the gearing output element, the toothed segment continues to rotate at a corresponding rotational speed in this operating state. This can, in particular, prevent the toothed segment from rubbing against the drive teeth. This operating state can occur, for example, if the brake shoe that is in operative connection with the gearing output element is in contact with the brake disk and is pressed against the brake disk. With the gearing assembly in the second embodiment, the running clearance of a brake can thus be quickly moved through in a rotational-angle-controlled manner in order to then press the brake shoe against the brake disk with a high torque and a short path.

In a third possible operating state, the gearing output element rotates in a second rotational direction opposite to the first rotational direction. This operating state can occur, for example, if the brake shoe that is in operative connection with the gearing output element moves away from the brake disk. The gearing assembly is preferably driven from the gearing output element. This can be achieved, for example, by designing the brake in which the gearing assembly is used in such a way that the removal of the brake shoes from the brake disk is driven by the release of a preload introduced into the brake when the brake is locked. Due to the principle of the overrunning second clutch, the second clutch couples the gearing output element to the second driven element in the second rotational direction. The corresponding rotation can be transmitted to the drive element. In addition, the toothed segment which is non-rotatably connected to the gearing output element is moved back accordingly so that it is again in engagement with the drive teeth of the first drive body. As a result, the second driven element is driven at a different rotational speed than the drive element. The third clutch decouples the first driven element from the drive element so that misalignment of the gearing assembly can be avoided.

In a development of the invention, the gearing assembly comprises a planetary gearset comprising a planet carrier, at least one planetary gear, which is arranged on the planet carrier, and a sun pinion, which is non-rotatably connected to a sun shaft and which sun pinion meshes with the at least one planetary gear. This allows for a large transmission ratio to be achieved in a relatively small installation space. To realize the function of a ring gear, a housing of the gearing assembly may have internal teeth with which the at least one planetary gear meshes.

The second driven element may be formed by the planet carrier. This makes it possible to gear down the second driven element in relation to the drive element.

The second drive body may be formed by the planet carrier and/or the second driven body may be formed by the gearing output element. This allows for a compact design and a smaller number of parts in the gearing assembly to be achieved. If at the same time the first driven body of the first clutch is formed by the gearing output element, the first driven body and the second driven body are identical.

The gearing output element may be arranged in a cylindrical recess in the planet carrier. Thus, the rotational axis of the gearing output element preferably is on the rotational axis of the sun shaft. The cylindrical recess may have a lateral surface which may be designed as the drive-side active surface of the second clutch. In this case, the rolling elements or clamping elements of the freewheel can interact directly with the lateral surface. This can contribute to a low number of parts in the gearing assembly.

The drive element can be formed by a drive gear that meshes with a sun gear arranged on the sun shaft. The term “drive gear” preferably also includes the drive gear shaft on which the gear may be arranged. The sun gear is preferably non-rotatably arranged on the sun shaft. Particularly preferably, the drive gear has a smaller diameter than the sun gear. This allows for a further gear-down to be realized.

The drive gear may be designed as a double gear with a first toothed ring and a second toothed ring non-rotatably connected to the first toothed ring, the second toothed ring meshing with the sun gear. Preferably, the second toothed ring has a smaller diameter than the first toothed ring. This means that a further gear-down can be achieved in a relatively small installation space. In particular, this can create a prerequisite for the use of a relatively high-speed DC motor. The first toothed ring preferably meshes with an output pinion of a driving electric motor.

In particular, in the first embodiment of the gearing assembly, the first driven element may be formed by the sun shaft. This makes it possible to achieve a lower transmission ratio of the first driven element in relation to the drive element compared to the second driven element, while at the same time maintaining a compact design of the gearing assembly.

In particular, in an alternative first embodiment of the invention, the first driven element may be formed by an additional shaft that is different from the sun shaft.

The additional shaft may have a different transmission ratio than the sun shaft in relation to the drive element. Compared to the sun shaft, the additional shaft may, in particular, have a lower transmission ratio in relation to the drive element. Accordingly, the additional shaft may have a higher rotational speed than the sun shaft. By means of the additional shaft, a larger rotational speed difference can be realized between the first driven element and the second driven element. In terms of the brake actuator, the running clearance can thus be moved through more quickly.

Preferably, the additional shaft is non-rotatably connected to an additional pinion, the additional pinion meshing with the first toothed ring. This means that the transmission ratio of the additional shaft in relation to the drive element, which ratio is different from that of the sun shaft, can be realized in a simple manner saving on space and parts. Particularly preferably, the additional pinion is formed integrally with the additional shaft. The additional pinion may be in the form of a toothed segment. This can be advantageous if the additional pinion is engaged for a rotational angle of less than 360°.

Particularly preferably, the sun shaft is designed as a hollow shaft and the additional shaft is arranged in the sun shaft. In particular, the additional shaft may be passed completely through the sun shaft so that the additional shaft projects beyond the sun shaft along its rotational axis in both directions. Such an arrangement allows for the advantages associated with the additional shaft to be realized in a small installation space. Furthermore, the remaining structure of the gearing assembly may be designed similarly to the structure of the embodiment without an additional shaft. This can be particularly advantageous from a manufacturing point of view.

A brake actuator according to the invention, which is designed, in particular, for a service brake of a motor vehicle, in particular a passenger car, has a gearing assembly as described above. Preferably, the brake actuator comprises an electric motor, particularly preferably a DC motor, which drives the drive element.

An exemplary embodiment of the invention is explained using the following figures. In the drawings:

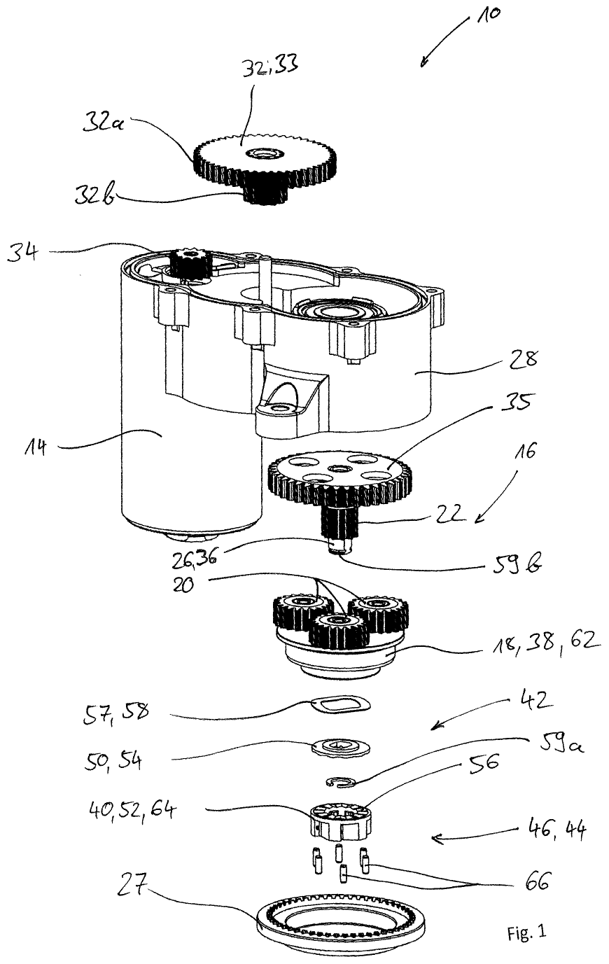

FIG. 1 is a schematic view of a brake actuator with an exploded view of a first exemplary embodiment of a gearing assembly;

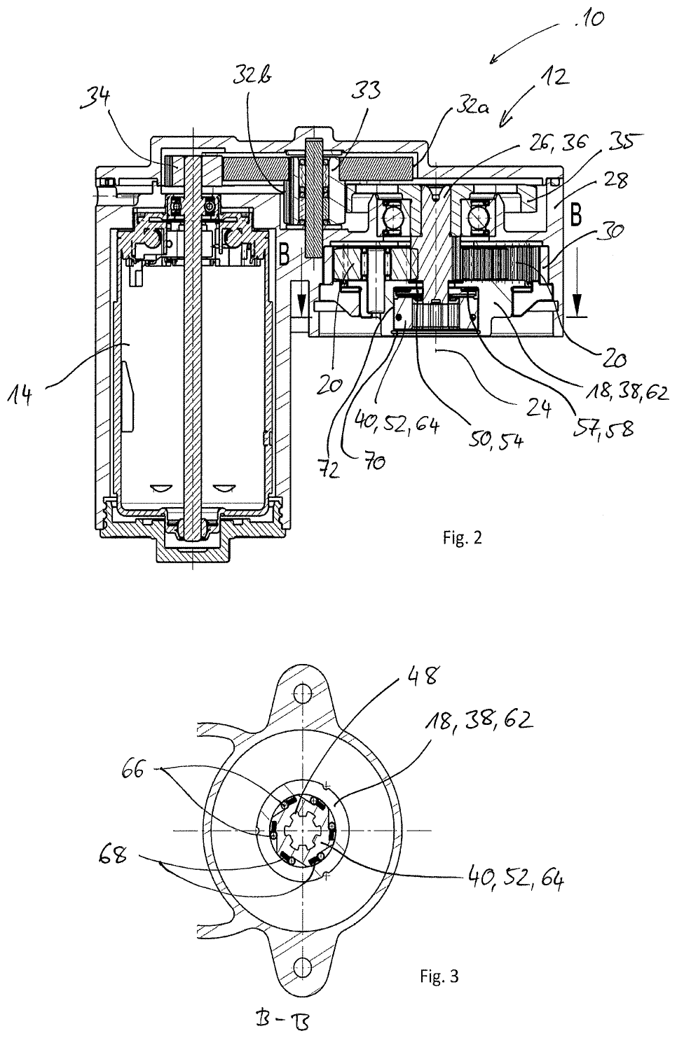

FIG. 2 is a sectional view of the brake actuator shown in FIG. 1 with section plane B-B marked;

FIG. 3 is the sectional view B-B of the brake actuator shown in FIG. 1 according to the section plane marked in FIG. 2;

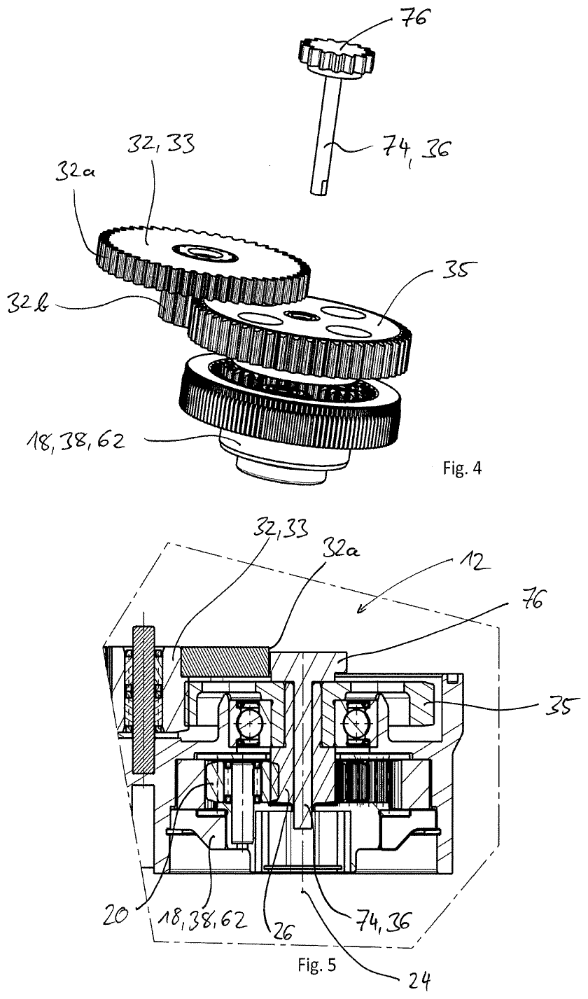

FIG. 4 is a perspective view of the gear train of a second exemplary embodiment of the gearing assembly;

FIG. 5 shows a partial section through the second exemplary embodiment of the gearing assembly;

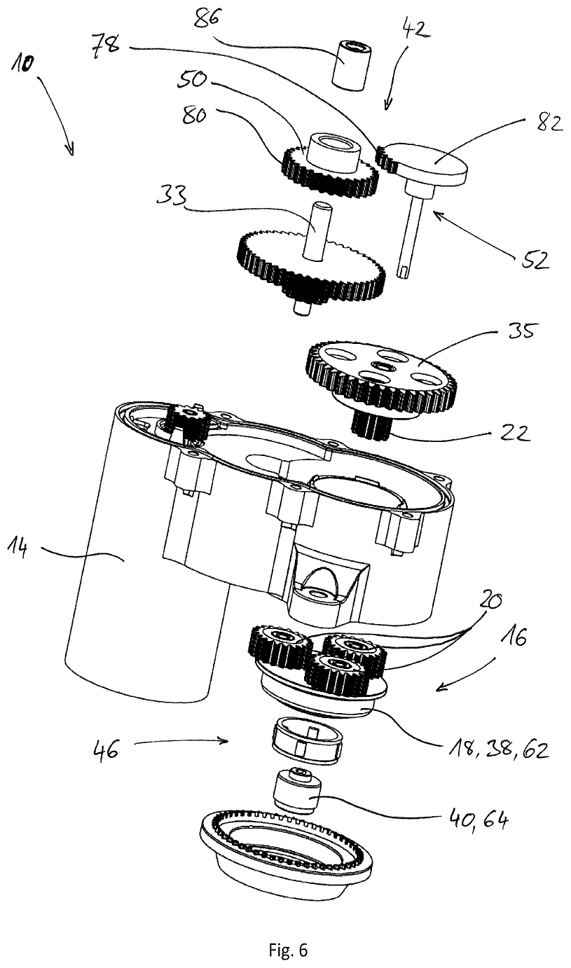

FIG. 6 is a schematic view of a brake actuator with an exploded view of a third exemplary embodiment of the gearing assembly;

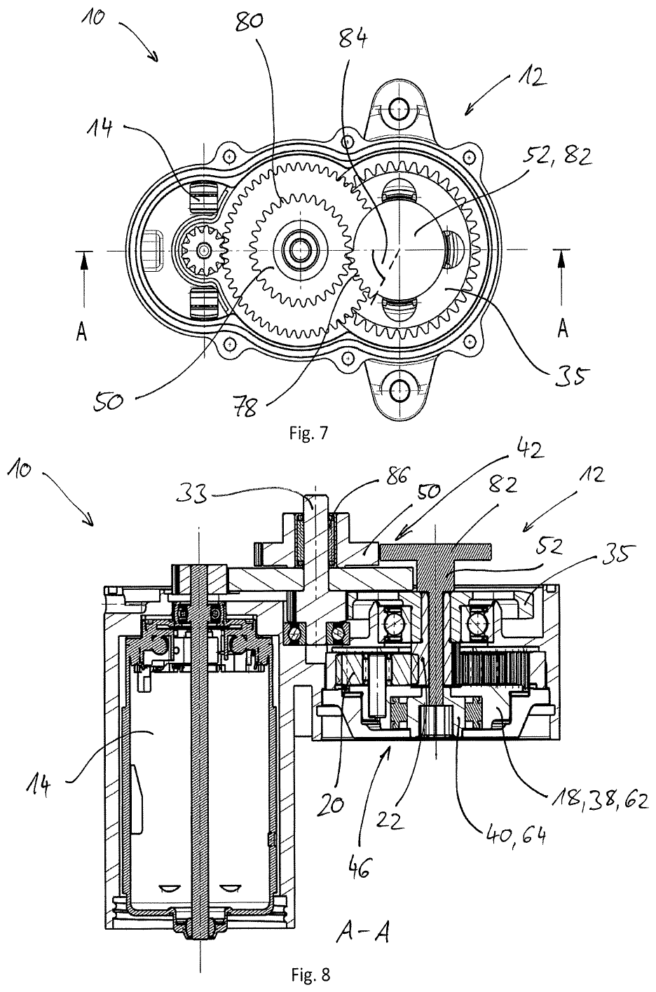

FIG. 7 is a top view of the exemplary embodiment shown in FIG. 6 with section plane A-A marked; and

FIG. 8 is the sectional view A-A of the brake actuator shown in FIG. 6 according to the section plane marked in FIG. 7.

FIGS. 1 to 8 are different views of different exemplary embodiments. For the sake of clarity, not all reference numbers are used in every figure. The same reference numbers are used for identical and functionally identical parts.

FIG. 1 shows a brake actuator 10 for the service brake of a motor vehicle, in particular a passenger car. FIG. 2 is a sectional view of said brake actuator 10. The brake actuator 10 comprises a first exemplary embodiment of a gearing assembly 12 and a DC motor 14. The gearing assembly 12 comprises a planetary gearset 16 comprising a planet carrier 18, three planetary gears 20, which are arranged on the planet carrier 18, and a sun pinion 22, which is non-rotatably arranged on a sun shaft 26 having a rotational axis 24. The planet carrier 18 is mounted by means of a plain bearing 27. In the exemplary embodiment shown in FIGS. 1 and 2, the toothing of the sun pinion 22 is machined out of the sun shaft 26. The sun pinion 22 meshes with the planetary gears 20. To realize the function of a ring gear, a housing 28 of the gearing assembly 12 may have internal teeth 30 with which the planetary gears 20 mesh.

The gearing assembly 12 also comprises a drive element 33 designed as a drive gear 32. The drive gear 32 is designed as a double gear with a first toothed ring 32a and a second toothed ring 32b non-rotatably connected to the first toothed ring 32a. The second toothed ring 32b has a smaller diameter than the first toothed ring 32a. As can be seen, in particular, from FIG. 2, the first toothed ring 32a meshes with an output pinion 34 of the driving DC motor 14. Due to the diameter ratio of the first toothed ring 32a to the output pinion 34, a gear-down takes place. The second toothed ring 32b meshes with a sun gear 35 arranged on the sun shaft 26. The sun gear 35 is non-rotatably arranged on the sun shaft 26. The second toothed ring 32b has a smaller diameter than the sun gear 35, so that a further gear-down is realized. The planetary gearset is thus driven via the sun shaft 26 and the sun pinion 22.

The gearing assembly 12 further comprises a first driven element 36 formed by the sun shaft 26 in the first exemplary embodiment shown in FIGS. 1 and 2, and a second driven element 38 formed by the planet carrier 18. When the gearing assembly 12 is in operation, a rotational speed and a torque can be picked up at the sun shaft 26 which differ from the rotational speed and the torque, respectively, that can be picked up at the planet carrier 18. As a result, with respect to the drive element 33, the first driven element 36 has a different transmission ratio than the second driven element 38. The gearing assembly 12 is configured in such a way that during operation the sun shaft 26 has a higher rotational speed and a lower torque than the planet carrier 18. In addition, the sun shaft 26 and the planet carrier 18 are coupled to the drive gear 32 such that they have the same rotational direction.

The gearing assembly 12 further comprises a gearing output element 40 shown in FIGS. 1 to 3. The sun shaft 26 can be coupled to the gearing output element 40 by a first clutch 42, which is shown in FIGS. 1 and 2 designed as a torque-limiting clutch. The planet carrier 18 can be coupled to the gearing output element 40 by a second clutch 46 which is designed as a roller-type freewheel 44 and is thus an overrunning clutch. In particular, in order to be able to establish an operative connection with, for example, a brake shoe, the gearing output element 40 has spline teeth 48.

The first clutch 42 has a first drive body 50 and a first driven body 52, wherein the driven body 52 is formed by the gearing output element 40. The drive body 50 is designed as a toothed disk 54 which has a toothed profile in the axial direction. The gearing output element 40 has a contour that can be brought into engagement with the toothed disk 54 on an end face 56 facing the toothed disk 54. The toothed disk 54 is non-rotatably connected to the sun shaft 26 and is preloaded against the gearing output element 40 by a spring element 58 designed as a spring washer 57. As a result, the first clutch 42 can couple the gearing output element 40 to the sun shaft 26 by means of a frictional and form-fitting connection. The assembly is held on the sun shaft 26 in the axial direction by means of a circlip 59a which engages in the locking groove 59b. By means of the preload and thus, in particular, by the choice of spring element 58, a torque limit can be set at which the first clutch 42 decouples the gearing output element 40 from the sun shaft 26.

In the present exemplary embodiment, the second clutch 46 is designed as a roller-type freewheel 44. The roller-type freewheel 44 has a second drive body 62 and a second driven body 64, wherein the second drive body 62 is formed by the planet carrier 18 and the second driven body 64 is formed by the gearing output element 40. The first driven body 52 of the first clutch 42 and the second driven body 64 of the second clutch 46 are therefore identical.

As shown, in particular, in FIG. 3, the roller-type freewheel 44 has rolling elements 66 that roll on the planet carrier 18 in the uncoupled state and are disengaged by clamping springs 68 in the coupled state and establish a frictional connection between the gearing output element 40 and the planet carrier 18. This enables a delay-free switching process from the coupling of the sun shaft 26 to the gearing output element 40 to the coupling of the planet carrier 18 to the gearing output element 40.

The gearing output element 40 may be arranged in a cylindrical recess 70 in the planet carrier 18. Thus, the rotational axis of the gearing output element 40 preferably is on the rotational axis 24 of the sun shaft 26. The cylindrical recess 70 has a lateral surface 72 which is designed as the drive-side active surface of the second clutch 46. The rolling elements 66 of the roller-type freewheel 44 therefore interact directly with the lateral surface 72.

With the above-described assembly of the first exemplary embodiment, depending on the load applied to the gearing output element 40 and the rotational direction of the sun shaft 26 and the second planet carrier 18, either the rotational speed and torque of the sun shaft 26 or the rotational speed and torque of the planet carrier 26 can be transmitted to the gearing output element 40. This allows for the transmission ratio of the gearing output element 40 to the drive gear 32 to be changed on the basis of the load applied to the gearing output element 40.

The operating principle of the first exemplary embodiment of the gearing assembly 12 will be described, in particular, with reference to FIG. 2 using three possible operating states.

In a first possible operating state, the sun shaft 26 and the planet carrier rotate in a first rotational direction. No load is applied to the gearing output element 40 or a load not exceeding the torque limit of the first clutch 42 is applied. The first clutch 42 couples the gearing output element 40 to the sun shaft 26. The roller-type freewheel 44 decouples the gearing output element 40 from the planet carrier 18 and thus enables the slower rotating planet carrier 18 to be “overtaken” by the faster rotating gearing output element 40, which is coupled to the sun shaft 26. The gearing output element 40 has the rotational speed and torque of the sun shaft 26. This operating state can occur, in particular, if a brake shoe that is in operative connection with the gearing output element 40 moves through the running clearance of a brake, i.e., the distance to coming into contact with the brake disk.

In a second possible operating state, the sun shaft 26 and the planet carrier 18 also rotate in the first rotational direction. A load exceeding the torque limit of the first clutch 42 is applied to the gearing output element 40. The first clutch 42 decouples the gearing output element 40 from the sun shaft 26. Once the rotational speed of the gearing output element 40 has dropped to the rotational speed of the planet carrier 18, the roller-type freewheel 44 couples the gearing output element 40 to the planet carrier 18. The gearing output element 40 thus has the rotational speed and torque of the planet carrier 18. This operating state can occur, in particular, if the brake shoe that is in operative connection with the gearing output element 40 is in contact with the brake disk and is pressed against the brake disk.

In a third possible operating state, the sun shaft 26 and the planet carrier 18 rotate in a second rotational direction opposite to the first rotational direction. No load is applied to the gearing output element 40 or a load not exceeding the torque limit of the first clutch 42 is applied. The first clutch 42 could therefore couple the gearing output element 40 to the sun shaft 26. Due to the principle of the roller-type freewheel 44, the higher rotational speed of the sun shaft 26 in the second rotational direction compared to the rotational speed of the planet carrier 18 leads to the gearing output element 40 becoming coupled to the planet carrier 18. As a result, the first clutch 42 decouples the gearing output element 40 from the sun shaft 16. The gearing output element 40 has the rotational speed and torque of the planet carrier 18. This operating state can occur, in particular, if the brake shoe that is in operative connection with the gearing output element 40 moves away from the brake disk.

FIGS. 4 and 5 show sections of the brake actuator 10 with a second exemplary embodiment of the gearing assembly 12. In contrast to the exemplary embodiment shown in FIGS. 1 to 3, the first driven element 36 is formed by an additional shaft 74 different from the sun shaft 26 instead of by the sun shaft 26. The additional shaft 74 is non-rotatably connected to an additional pinion 76, which meshes with the first toothed ring 32a. Particularly preferably, the additional pinion 76 is formed integrally with the additional shaft 74.

Compared to the sun shaft 26, the additional shaft thus has a lower transmission ratio in relation to the drive gear 32. Accordingly, the additional shaft 74 has a higher rotational speed than the sun shaft 26. By means of the additional shaft 74, a larger rotational speed difference can be realized between the first driven element 36 and the second driven element 38, i.e., the planet carrier 18. In terms of the brake actuator 10, the running clearance can thus be moved through faster.

As can be seen from FIG. 5, in the second exemplary embodiment the sun shaft 26 is designed as a hollow shaft and the additional shaft 74 is arranged in the sun shaft 26. In this case the additional shaft 74 passes completely through the sun shaft 26 so that it projects beyond the sun shaft 26 along its rotational axis 24 in both directions. As a result, the remaining structure of the second exemplary embodiment of the gearing assembly 12 and of the brake actuator 10 may be designed identically to the structure of the first exemplary embodiment of the gearing assembly 12. The gearing output element 40 as well as the first clutch 42 and—apart from the planet carrier 18 as the drive body 62—the second clutch 46 are not shown in FIG. 5 for the sake of clarity.

FIG. 6 shows a brake actuator with a third exemplary embodiment of the gearing assembly 12. In this case, the first clutch 42, in contrast to the previously explained exemplary embodiments, is designed as a rotational-angle-actuated clutch. The first driven body 50 in this case has a toothed segment 78 which is non-rotatably coupled to the gearing output element 40. In addition, the first drive body 50 has drive teeth 80 which, as shown in FIG. 7, can be brought into engagement with the toothed segment 78. Accordingly, the toothed segment 78 may be arranged, for example, on the circumference of a toothed-segment gear 82 over a toothed-segment angle 84 of less than 360°. This means that the toothed segment 78 can engage with the drive teeth 80 only within the toothed-segment angle 84. Furthermore, there is no longer any force transmission between the drive teeth 80 and the toothed segment 78. The first drive body 50 and the first driven body 52 may thus be decoupled from each other. The first drive body 50 may be formed by the first driven element 36.

Depending on the rotational angle of the first driven body 52, either the rotational speed and torque of the first driven element 36 or the rotational speed and torque of the second driven element 38 can be transmitted to the gearing output element 40. This allows for the transmission ratio of the gearing output element 40 to the drive element 33 to be changed on the basis of the rotational angle of the first driven body 52.

In the third exemplary embodiment, the first driven element 36 can be coupled to the drive element 33 by means of a third clutch 86 shown in FIGS. 6 and 8. As a result, the force path comprising the first driven element 36 and the force path comprising the second driven element 38 can be decoupled from one another on the side of the drive element 33. In the case of rotation in the first rotational direction, the decoupling is preferably achieved by the overrunning second clutch 46, which is in principle identical to the first exemplary embodiment. In the case of rotation in the second rotational direction, which in the third exemplary embodiment is preferably driven from the gearing output element 40, the second clutch 46 is closed due to the principle of overrunning actuation. The first clutch 42, designed as a rotational-angle-actuated clutch, is typically not able to open in the event of a torque increase caused by the misalignment of the gearing assembly 12, as can happen in the first and second exemplary embodiment. Misalignment of the gearing can therefore be avoided by providing the third clutch 86.

The third clutch 86 shown in FIGS. 6 and 8 is designed as a freewheel and thus a overrunning clutch. This allows for the first driven element 36 to be driven by the drive element 33 in the first rotational direction, whereas, in the second rotational direction, misalignment of the gearing assembly 12 can be avoided.

The operating principle of the third exemplary embodiment of the gearing assembly 12 will be described in particular with reference to FIGS. 7 and 8 using three possible operating states.

In a first possible operating state, the drive element 33 rotates in a first rotational direction, so that the second driven element 38, which is preferably non-rotatably coupled to the drive element 33, also rotates in a first rotational direction. The third clutch 86 is configured to transmit torque from the drive element 33 to the first driven element 36 in the first rotational direction. The drive teeth 80 of the first drive body 50 engage with the toothed segment 78 so that the first clutch 42 couples the gearing output element 40 to the first driven element 36. The second clutch 46 decouples the gearing output element 40 from the second driven element 38 and thus enables the slower rotating second driven element 38 to be “overtaken” by the faster rotating gearing output element 40. Rotational speed and torque are transmitted from the first driven element 36 to the gearing output element 40, which also rotates in a first rotational direction. This operating state can occur, for example, if a brake shoe that is in operative connection with the gearing output element 40 moves through the running clearance of a brake, i.e., the distance to coming into contact with the brake disk.

In a second possible operating state, the drive element 33 also rotates in the first rotational direction. The toothed segment 78 has moved so far that there is no longer any force transmission between the drive teeth 80 and the toothed segment 78. The first clutch 42 thus decouples the gearing output element 40 from the first driven element 36. Once the rotational speed of the gearing output element 40 has dropped to at least the rotational speed of the second driven element 38, the second clutch 46 couples the gearing output element 40 to the second driven element 38. Rotational speed and torque are transmitted from the second driven element 38 to the gearing output element 40. The gearing output element 40 rotates in the first rotational direction. Since the toothed segment 78 is non-rotatably connected to the gearing output element 40, the toothed segment 78 continues to rotate at the rotational speed of the gearing output element 40 in this operating state. This can in particular prevent the toothed segment 78 from rubbing against the drive teeth 80. This operating state can occur, for example, if the brake shoe that is in operative connection with the gearing output element 40 is in contact with the brake disk and is pressed against the brake disk. With the gearing assembly 12 in the second embodiment, the running clearance of a brake can thus be quickly moved through in a rotational-angle-controlled manner in order to then press the brake shoe against the brake disk with a high torque and a short path.

In a third possible operating state, the gearing output element 40 rotates in a second rotational direction opposite to the first rotational direction. This operating state can occur, for example, if the brake shoe that is in operative connection with the gearing output element 40 moves away from the brake disk. The gearing assembly 12 is then preferably driven from the gearing output element 40. This can be achieved, for example, by designing the brake in which the gearing assembly 12 is used in such a way that the removal of the brake shoes from the brake disk is driven by the release of a preload introduced into the brake when the brake is locked. Due to the principle of the overrunning second clutch 46, the second clutch 46 couples the gearing output element 40 to the second driven element 38 in this case in the second rotational direction. The corresponding rotation is transmitted to the drive element 33. In addition, the toothed segment 78 which is non-rotatably connected to the gearing output element 40 is moved back accordingly so that it is again in engagement with the drive teeth 80 of the first drive body 50. As a result, the second driven element 38 is driven at a different rotational speed than the drive element 33. The third clutch 86 decouples the first driven element 36 from the drive element 33 so that misalignment of the gearing assembly 12 can be avoided.

### LIST OF REFERENCE NUMERALS

10 Brake actuator
12 Gearing assembly
14 DC motor
16 Planetary gearset
18 Planet carrier
20 Planetary gear
22 Sun pinion
24 Rotational axis
26 Sun shaft
27 Plain bearing
28 Housing
30 Internal teeth
32 Drive gear
32a First toothed ring
32b Second toothed ring
33 Drive element
34 Output pinion
35 Sun gear
36 First driven element
38 Second driven element
40 Gearing output element
42 First clutch
44 Roller-type freewheel
46 Second clutch
48 Spline teeth
50 First drive body
52 First driven body
54 Toothed disk
56 End face
57 Spring washer
58 Spring element
59a Circlip
59b Locking groove
62 Second drive body
64 Second driven body
66 Rolling elements
68 Clamping spring
70 Recess
72 Lateral surface
74 Additional shaft
76 Additional pinion
78 Toothed segment
80 Drive teeth
82 Toothed-segment gear
84 Toothed-segment angle
86 Third clutch

1. A gearing assembly (12) for a brake actuator (10), comprising the following features:
a drive element (33),
a first driven element (36),
a second driven element (38), and
a gearing output element (40),
wherein, with respect to the drive element (33), the first driven element (36) has a different transmission ratio than the second driven element (38),
wherein the first driven element (36) can be coupled to the gearing output element (40) by a first clutch (42), which comprises a first drive body (50) and a first driven body (52), and
wherein the second driven element (38) can be coupled to the gearing output element (40) by a second clutch (46), which comprises a second drive body (62) and a second driven body (64) and is designed as an overrunning clutch.

2. The gearing assembly according to claim 1, characterized in that the first clutch (42) is designed as a torque-limiting clutch.

3. The gearing assembly according to claim 2, characterized in that the first drive body (50) is non-rotatably connected to the first driven element (36) and is preloaded against the first driven body (52) by a spring element (58).

4. The gearing assembly according to claim 3, characterized in that the first driven body (52) is formed by the gearing output element (40).

5. The gearing assembly according to claim 4, characterized in that the first drive body (50) of the first clutch (42) is designed as a toothed disk (54) and the gearing output element (40) has a contour that can be brought into engagement with the toothed disk (54) on an end face (56) facing the toothed disk (54).

6. The gearing assembly according to claim 1, characterized in that the first clutch (42) is designed as a rotational-angle-actuated clutch.

7. The gearing assembly according to claim 6, characterized in that the first driven body has a toothed segment which is non-rotatably coupled to the gearing output element, and the first drive body has drive teeth which can be brought into engagement with the toothed segment.

8. The gearing assembly according to claim 6, characterized in that the first driven element can be coupled to the drive element by means of a third clutch.

9. The gearing assembly according to claim 8, characterized in that the third clutch is designed as an overrunning clutch.

10. The gearing assembly according to claim 1, characterized in that the gearing assembly (12) comprises a planetary gearset (16) comprising
a planetary carrier (18),
at least one planetary gear (20), which is arranged on the planet carrier (18), and
a sun pinion (22), which is non-rotatably connected to a sun shaft (26) and which meshes with the at least one planetary gear (20).

11. The gearing assembly according to claim 10, characterized in that the second driven element (38) is formed by the planet carrier (18).

12. The gearing assembly according to claim 11, characterized in that the second drive body (62) is formed by the planet carrier (18) and/or the second driven body (64) is formed by the gearing output element (40).

13. The gearing assembly according to claim 10, characterized in that the first driven element (36) is formed by the sun shaft (26).

14. The gearing assembly according to claim 10, characterized in that the first driven element (36) is formed by an additional shaft (74), which is different than the sun shaft (26).

15. The gearing assembly according to claim 14, characterized in that the additional shaft (74), with respect to the drive element (33), has a different transmission ratio than the sun shaft (26).

16. nA brake actuator (10), in particular for a service brake of a motor vehicle, comprising a gearing assembly (10) according to claim 1.
